(19) United States
(12) Patent Application Publication
(10) Pub. No.: US 2006/0232195 A1
(43) Pub. Date: Oct. 19, 2006

(54) OLED device having improved light output

(75) Inventors: Ronald S. Cok, Rochester, NY (US); Joel D. Shore, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/106,277

(22) Filed: Apr. 14, 2005

(51) Int. Cl. H01J 1/62; H01J 63/04

(52) U.S. Cl. 313/504

(57) ABSTRACT

An organic light-emitting diode (OLED) device, comprising: a reflective element, a partially reflective semi-transparent electrode through which light from the OLED is emitted, and at least one layer of organic light-emitting material disposed between the reflective element and the partially reflective semi-transparent electrode; wherein either the reflective element comprises a reflective electrode or a transparent electrode is positioned between the reflective element and the organic light emitting material, and further comprising a light scattering element optically integrated into the OLED device for scattering light emitted by the light-emitting layer and reflected by the reflective element and the partially reflective semi-transparent electrode.

### FIELD OF THE INVENTION

The present invention relates to organic light-emitting diode (OLED) devices and, more particularly, to an OLED device having improved light output and power distribution.

### BACKGROUND OF THE INVENTION

Organic light-emitting diode (OLED) devices, also referred to as organic electroluminescent (EL) devices, have numerous well-known advantages over other flat-panel display devices currently in the market place. Among the potential advantages are brightness of light emission, relatively wide viewing angle, reduced device thickness, and reduced electrical power consumption compared to, for example, liquid crystal displays (LCDs) using backlighting.

Applications of OLED devices include active-matrix image displays, passive-matrix image displays, and area-lighting devices such as, for example, selective desktop lighting. Irrespective of the particular OLED device configuration tailored to these broad fields of applications, all OLEDs function on the same general principles. An organic electroluminescent (EL) medium structure is sandwiched between two electrodes. At least one of the electrodes is at least partially light transmissive. These electrodes are commonly referred to as an anode and a cathode in analogy to the terminals of a conventional diode. When an electrical potential is applied between the electrodes so that the anode is connected to the positive terminal of a voltage source and the cathode is connected to the negative terminal, the OLED is said to be forward biased. Positive charge carriers (holes) are injected from the anode into the EL medium structure, and negative charge carriers (electrons) are injected from the cathode. Such charge carrier injection causes current flow from the electrodes through the EL medium structure. Recombination of holes and electrons within a zone of the EL medium structure results in emission of light from this zone that is, appropriately, called the light-emitting zone or interface. The organic EL medium structure can be formed of a stack of sublayers that can include small molecule layers and polymer layers. Such organic layers and sublayers are well known and understood by those skilled in the OLED art.

Referring to FIG. 2, a top-emitting OLED device as proposed in the prior art is illustrated having a substrate 10 (either reflective, transparent, or opaque), a patterned reflective electrode 12 defining pixels 30, 32, 34, 36, 38, one or more layers 14 of organic material, one of which is light-emitting, a transparent electrode 17, a gap 19 and an encapsulating cover 20. The encapsulating cover 20 is transparent and may be coated directly over the transparent electrode 17 so that no gap 19 exists. It has been proposed to fill the gap with polymeric or desiccating material. Such polymers and desiccants typically will have indices of refraction greater than or equal to that of the substrate 10 or encapsulating cover 20, and it is generally proposed to employ materials having indices of refraction roughly matched to that of the encapsulating cover to reduce interlayer reflections. Light emitted from one of the organic material layers 14 can be emitted directly out of the device, through the encapsulating cover 20. In some prior-art embodiments, the first electrode 12 may instead be at least partially transparent and/or light absorbing.

Full-color OLED devices may employ a variety of organic materials to emit different colors of light. In this arrangement, the OLED device is patterned with different sets of organic materials, each set of organic materials associated with a particular color of light emitted. Each pixel in an active-matrix full-color OLED device typically employs each set of organic materials, for example to form a red, green, and blue sub-pixel. The patterning is typically done by evaporating layers of organic materials through a mask. In an alternative arrangement, a single set of organic materials emitting broadband light may be deposited in continuous layers on either the substrate (for a top-emitter) or cover (for a bottom-emitter) with arrays of differently colored filters employed to create a full-color OLED device.

The emitted light is directed towards an observer, or towards an object to be illuminated, through the light transmissive electrode. If the light transmissive electrode is between the substrate and the light emissive elements of the OLED device, the device is called a bottom-emitting OLED device. Conversely, if the light transmissive electrode is not between the substrate and the light emissive elements, the device is referred to as a top-emitting OLED device. The present invention may be directed to either a top-emitting or bottom-emitting OLED device. However, in one embodiment, because of the limitations on a transparent electrode that are overcome in the present invention, a top-emitting OLED device is preferred.

In top-emitting OLED devices, light is emitted through an upper electrode or top electrode, typically but not necessarily the cathode, which has to be sufficiently light transmissive, while the lower electrode(s) or bottom electrode(s), typically but not necessarily the anode, can be made of relatively thick and electrically conductive metal compositions which can be optically opaque. Because light is emitted through an electrode, it is important that the electrode through which light is emitted be sufficiently light transmissive to avoid absorbing the emitted light. Typical prior-art materials proposed for such electrodes include indium tin oxide (ITO) and very thin layers of metal, for example silver or metal alloys including silver. However, the current carrying capacity of such electrodes is limited, thereby limiting the amount of light that can be emitted from the organic layers.

Applicants have demonstrated that in order to supply adequate uniform current to an OLED while permitting adequate amounts of light to escape from the device without employing additional electrode bussing, the sheet resistance of a transparent electrode suitable for use in a prior-art top-emitter OLED device configuration such as FIG. 2 should be less than 3.2 ohms per square, more preferably less than 2.0 ohms per square, and most preferably less than 1.0 ohm per square, while also preferably providing a transparency of at least 50%, more preferably at least 70%. For large OLED devices (greater than 5 inches in diagonal), the preferred resistance requirements are lower still. While highly light-transmissive electrode materials such as ITO have been proposed for top-emitting devices, ITO does not provide as high a conductivity as may be desired.

The use of sufficiently thin metal layers providing at least partial transparency may alternatively be employed to provide adequate conductivity. For instance, microcavity structures employing a highly reflective bottom electrode and a partially reflective, semi-transparent continuous top electrode have been proposed as a means for increasing the light output from the OLED device. By carefully tuning the thickness of the layers between these two electrodes, an appropriate color of light with increased brightness can be emitted from the OLED, even with the metal upper electrode. Applicants have demonstrated good results with a 20 nm thick layer of silver as an upper electrode and an aluminum or silver bottom anode. 20 nm of silver may have a sheet resistance of 0.80 ohms per square. Such microcavity designs are known in the art, see for example US 2004/0140757 and 2004/0155576. US 2005/0073228 describes a white-light emitting OLED apparatus comprising a microcavity OLED device and a light-integrating element, wherein the microcavity OLED device has a white light emitting organic EL element and the microcavity OLED device is configured to have angular-dependent narrow-band emission, and the light-integrating element integrates the angular-dependent narrow-band emission from different angles from the microcavity OLED device to form white light emission. However, such microcavity designs require very precise control of layer thicknesses in order to obtain the desired color, and may also create a strong angular dependence on the color of light emitted, especially if broadband emitters are employed, and do not emit all of the light created in the OLED.

In an alternative approach to overcoming the problem of inadequate transparent electrode materials, a transparent electrode bussing scheme may be considered. Referring to FIG. 2 again, in such an arrangement, transparent electrode busses 41 for the transparent electrode 17 are formed over the OLED device substrate 10 and vias 40 are created through the organic layers 14. When the transparent electrode 17 is deposited over the organic layers 14, it will also be deposited over the vias 40 to connect the transparent electrode 17 to the transparent electrode bus 41. Electrode busses 41 may be separated from electrode 12 with insulator 42. Most of the current distribution is then conducted through the transparent electrode busses 41 and a relatively less conductive and more transparent electrode 17 may be employed over the organic layers 14, for example ITO. Such an approach is described in US 2004/0253756. Other related designs employ auxiliary electrodes to distribute power to a top electrode. For example, U.S. Patent Application Publication 2002/0011783 A1, U.S. Patent Application Publication 2001/0043046 A1, and U.S. Patent Application Publication 2002/0158835 A1 describe the use of auxiliary conductive elements electrically connected to the top electrode. However, these approaches all have the disadvantage of requiring that additional patterning steps be employed to form vias or to otherwise pattern the top electrode.

A typical top-emitter OLED device as proposed in the art uses a glass substrate, a reflective conducting anode comprising a metal, for example aluminum, a stack of organic layers, and a transparent cathode layer, employing, for example indium-tin-oxide (ITO). Light generated from the device is emitted through the top transparent electrode. However, as noted above, applicants have determined that the ITO is insufficiently conductive for most practical applications. Such proposed devices will not be bright enough and will be subject to variability in light output over the surface of the device due to resistance variations at different locations on the device. Moreover, in these typical devices, the index of the ITO layer, the organic layers, and the glass is about 2.0, 1.7, and 1.5 respectively. It has been estimated that nearly 60% of the generated light is trapped by internal reflection in the ITO/organic EL element, 20% is trapped in the glass substrate, and only about 20% of the generated light is actually emitted from the device and performs useful functions.

A variety of techniques have been proposed to improve the out-coupling of light from thin-film light emitting devices. For example, diffraction gratings have been proposed to control the attributes of light emission from thin polymer films by inducing Bragg scattering of light that is guided laterally through the emissive layers; see “Modification of polymer light emission by lateral microstructure” by Safonov et al., Synthetic Metals 116, 145-148 (2001) and “Bragg scattering from periodically microstructured light emitting diodes” by Lupton et al., Applied Physics Letters. 77, 3340-3342 (2000). Brightness enhancement films having diffractive properties and surface and volume diffusers are described in WO0237568 A1 entitled “Brightness and Contrast Enhancement of Direct View Emissive Displays” by Chou et al., published May 10, 2002. However, such diffractive techniques cause a significant frequency dependence on the angle of emission so that the color of the light emitted from the device changes with the viewer's perspective.

Scattering techniques are also known to improve light output from an OLED device. Chou (International Publication Number WO 02/37580 A1) and Liu et al. (U.S. Patent Application Publication No. 2001/0026124 A1) taught the use of a volume or surface scattering layer to improve light extraction. The scattering layer is applied next to the organic layers or on the outside surface of the glass substrate or cover and has an optical index that matches these layers. Light emitted from the OLED device at higher than critical angle that would have otherwise been trapped can penetrate into the scattering layer and be scattered out of the device.

Light-scattering layers used externally to an OLED device are described in U.S. Patent Application Publication No. 2005/0018431 entitled “Organic electroluminescent devices having improved light extraction” by Shiang and U.S. Pat. No. 5,955,837 entitled “System with an active layer of a medium having light-scattering properties for flat-panel display devices” by Horikx, et al. These disclosures describe and define properties of scattering layers located on a substrate in detail. Likewise, U.S. Pat. No. 6,777,871 entitled “Organic ElectroLuminescent Devices with Enhanced Light Extraction” by Duggal et al. describes the use of an output coupler comprising a composite layer having specific refractive indices and scattering properties.

The use of light scattering techniques may increase the light-output efficiency of an OLED device, but have not been proposed to address the difficulty of providing a sufficiently transparent top electrode with adequate conductivity.

There is a need therefore for an improved organic light-emitting diode device structure that increases the light output, that does not exhibit a color dependence on angle of emission, and that provides improved conductivity of the transparent electrode without a burdensome manufacturing process.

### SUMMARY OF THE INVENTION

In accordance with one embodiment, the invention is directed towards an organic light-emitting diode (OLED) device, comprising: a reflective element, a partially reflective semi-transparent electrode through which light from the OLED is emitted, and at least one layer of organic light-emitting material disposed between the reflective element and the partially reflective semi-transparent electrode; wherein either the reflective element comprises a reflective electrode or a transparent electrode is positioned between the reflective element and the organic light emitting material, and further comprising a light scattering element optically integrated into the OLED device for scattering light emitted by the light-emitting layer and reflected by the reflective element and the partially reflective semi-transparent electrode.

### ADVANTAGES

The present invention has the advantage that it increases the light output from, and reduces the manufacturing cost of, an OLED device.

### BRIEF DESCRIPTION OF THE DRAWINGS

FIG. 1 illustrates a cross section of a top-emitter OLED device having a scattering element according to one embodiment of the present invention;

FIG. 2 illustrates a cross section of a prior-art top-emitter OLED device;

FIG. 3 is a graph illustrating the conductivity and transparency of various materials useful for a transparent electrode of an OLED device;

FIG. 4 illustrates a cross section of a top-emitter OLED device having a scattering element according to another embodiment of the present invention;

FIG. 5 illustrates a cross section of a top-emitter OLED device having a scattering element according to yet another embodiment of the present invention;

FIG. 6 illustrates a cross section of a top-emitter OLED device having reflective, scattering, and transparent electrode layers according to yet another embodiment of the present invention;

FIG. 7 illustrates a cross section of a top-emitter OLED device having scattering particles according to yet another embodiment of the present invention;

FIG. 8 illustrates a cross section of a top-emitter OLED device having an electrode with a scattering surface according to yet another embodiment of the present invention;

FIG. 9 illustrates a cross section of a top-emitter OLED device having an electrode encapsulation layer according to yet another embodiment of the present invention;

FIG. 10 illustrates a cross section of a top-emitter OLED device having color filters according to an alternative embodiment of the present invention; and

FIG. 11 is a graph illustrating the fraction of the light that can be extracted from an OLED device as obtained from an optical model of an embodiment of the present invention;

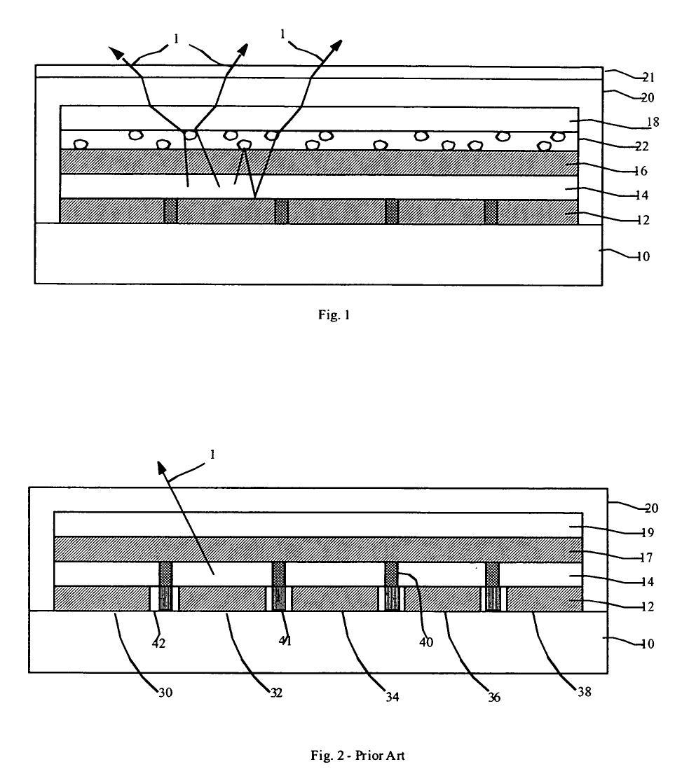

It will be understood that the figures are not to scale since the individual layers are too thin and the thickness differences of various layers too great to permit depiction to scale.

### DETAILED DESCRIPTION OF THE INVENTION

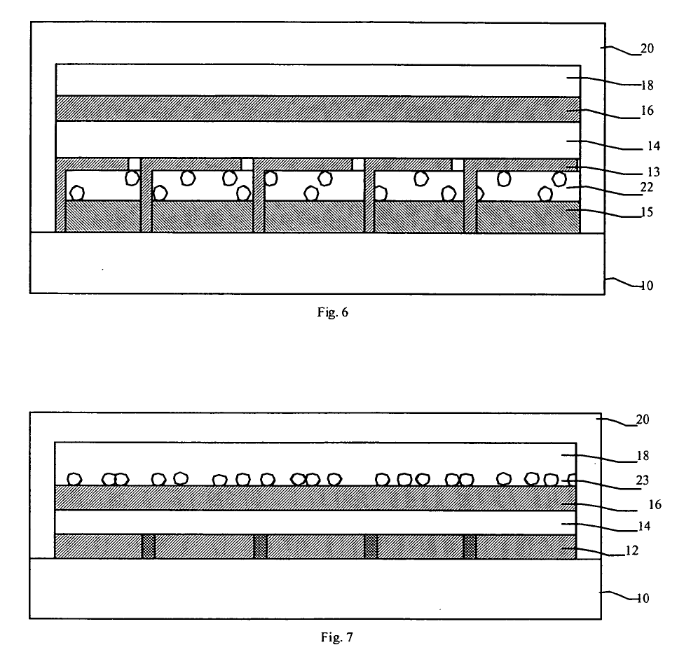

Referring to FIG. 1, in accordance with one embodiment of the present invention, an organic light-emitting diode (OLED) device, comprising: a reflective element 12, a partially reflective semi-transparent electrode 16 through which light from the OLED is emitted, and at least one layer 14 of organic light-emitting material disposed between the reflective element 12 and the partially reflective semi-transparent electrode 16. In this embodiment, reflective element 12 comprises a reflective electrode. The OLED device further comprises a light scattering element 22 optically integrated into the OLED device for scattering light emitted by the light-emitting layer and reflected by the reflective element 12 and the partially reflective semi-transparent electrode 16. In an alternative embodiment (see, e.g., FIG. 6 discussed below), a transparent electrode 13 may be positioned between a reflective element layer 15 and the organic light emitting material layer 14. In either embodiment, while the electrode 16 must be partially reflective and semi-transparent, the reflective elements 12 or 15 may be substantially totally reflective, or partially reflective and semi-transparent and/or semi-absorptive. Scattering element 22 may be located between the reflective element 12 or 15 and the partially reflective semi-transparent electrode 16, or adjacent to and in contact with the reflective element 12 or 15 or the partially reflective semi-transparent electrode 16. In the particular embodiment of FIG. 6, scattering element 22 may be located between the reflective element 15 and the transparent electrode 13. Alternatively, the light scattering element 22 may be optically integrated into the partially reflective semi-transparent electrode 16 or the reflective element 12 or 15. In such alternatives, the reflective element 12 or 15 may itself comprise a scattering reflective layer, or the partially reflective semi-transparent electrode 16 may itself comprise a light-scattering partially reflective semi-transparent electrode 16.

The OLED device may further comprise a substrate 10 whereon the OLED is formed and an encapsulating cover 20 to seal and protect the OLED device. The reflective element electrode 12 or transparent electrode 13 may be pixelated to form distinct light emitting areas. The partially reflective semi-transparent electrode 16 may also be patterned or it may be a continuous, unpatterned layer (as shown). The partially reflective semi-transparent electrode 16 preferably has a transparency of at least 20%, more preferably at least 50%, and most preferably at least 70% at 550 nm. In a particular embodiment, the partially reflective semi-transparent electrode may have a transparency of from 20% to 90% at 550 nm. The organic material layers 14 may comprise organic materials known in the art, for example, hole-injection, hole-transport, light-emitting, electron-injection, and/or electron-transport layers. Such organic material layers are well known in the OLED art.

As employed herein, a light scattering element is an optical layer or surface that tends to randomly redirect any light that impinges on the layer or surface from any direction. The light scattering element 22 is optically integrated into the OLED device for scattering light emitted by the light-emitting layer and reflected by the reflective element 12 or 15 and the partially reflective semi-transparent electrode 16. The presence of an optically integrated scattering layer in accordance with the present invention defeats standing waves that might otherwise form between the reflective element 12 or 15 and the partially reflective semi-transparent electrode 16, and thereby substantially prevents an optical microcavity from forming. This, in turn, reduces or eliminates any dependency on angle for the light that is emitted from the OLED.

If the light scattering element 22 is located between the reflective element 12 or 15 and the partially reflective semi-transparent electrode 16, optical integration means that light reflected between the reflective element 12 or 15 and the partially reflective semi-transparent electrode 16 is modified so as to be redirected. If the light scattering element 22 is a part of either the reflective element 12 or 15 or the partially reflective semi-transparent electrode 16, optical integration means that the reflective optical behavior of the reflective element 12 or 15 or partially reflective semi-transparent electrode 16 is modified. For example, a light scattering element integrated into the reflective element causes the reflective element to scatter the reflected light and may be accomplished by constructing a reflector that has a rough surface rather than a smooth planar surface. If the light scattering element is integrated into a transparent, partially reflective, or reflective electrode, it causes the electrode to scatter the light that passes through or is reflected from the electrode and may be accomplished by constructing the transparent electrode with a transparent conductive scattering layer, a partially reflective, or a reflective scattering layer. The scattering element may also be optically integrated with a reflective or partially reflective layer if it is formed on the side of the reflective or partially reflective layer opposite the side adjacent to the light emitting layer and the reflective or partially reflective layer is sufficiently thin that the light encounters the scattering elements when it impinges on the reflective or partially reflective layer, for example if the reflective or partially reflective layer has a thickness less than the wavelength of the light reflected.

A transparent low-index layer 18 (possibly an air gap) having a refractive index lower than the refractive index of the cover 20 and organic layers 14 may be located between the scattering element 22 and the encapsulating cover 20. The use of a transparent low-index layer 18 having a refractive index lower than the refractive index of the encapsulating cover 20 and organic layers 14 to enhance the sharpness of an OLED device having a scattering element 22 is described in co-pending, commonly assigned U.S. Ser. No. 11/065,082 filed Feb. 24, 2005, the disclosure of which is hereby incorporated by reference, and may be employed in concert with the present invention.

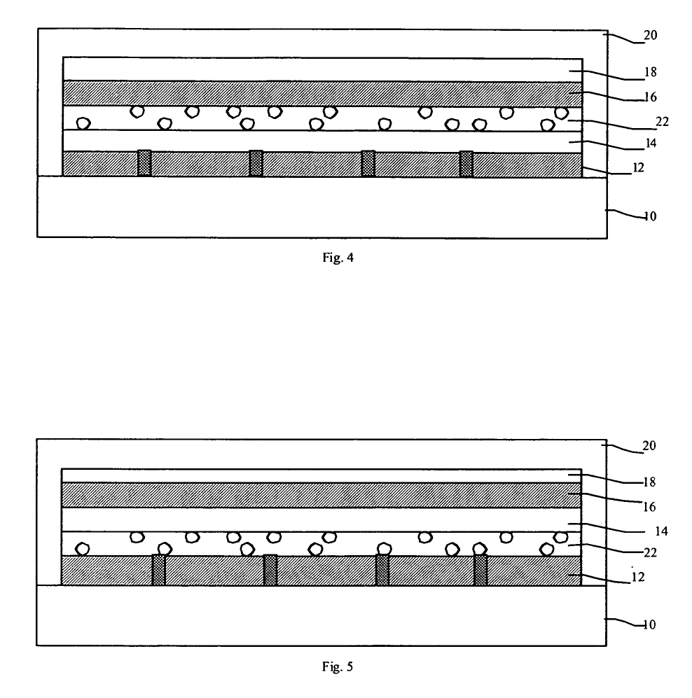

In various embodiments the scattering element 22 may be adjacent to the partially reflective semi-transparent electrode 16 opposite the organic layers 14 or between the reflective element 12 and the partially reflective semi-transparent electrode 16 as illustrated in FIGS. 1, 4 and 5. In yet another embodiment, illustrated in FIG. 6, the scattering layer 22 may be located between a reflective layer 15 and a transparent electrode 13. The reflective layer 15 may also be electrically conductive, as may the scattering layer 22. The reflective layer 15 is preferably made of a metal with high reflectivity such as silver, aluminum, or magnesium silver.

Partially reflective semi-transparent electrode 16 is preferably made of metal, metal oxides, or metal alloys, for example aluminum, silver, ytterbium, magnesium silver, or indium tin oxide, or combinations of layers of such materials, and may incorporate other dopants and/or layers such as lithium and molybdenum to enhance the conductivity or electron-injection capabilities of the partially reflective semi-transparent electrode 16. To provide the advantage of increased conductivity and lower sheet resistance (e.g., preferably of less than 3.20, more preferably less than 2.0 and most preferably less than 1.0 ohms per square) while obtaining sufficient transparency, semi-transparent electrode 16 preferably comprises a metal layer of at least about 5 nanometers to provide adequate current-carrying capability, and may more preferably have a thickness of 10 nm or 20 nm or more to provide additional conductivity. The metal layer thickness is also preferably less than 50 nm, however, to enable sufficient transparency. Such metal layers will typically reflect at least a few percent, and more typically at least 10 percent, of emitted light. In the absence of employing a scattering element 22 in accordance with the invention, such reflected light will create an undesired dependence on viewing angle for the color of light emitted from the device. In a preferred embodiment, partially reflective semi-transparent electrode 16 comprises silver.

According to an embodiment of the present invention, the partially reflective semi-transparent electrode 16 is unpatterned and does not include additional patterned material, for example a grid pattern of thick conductors either formed directly on the partially reflective semi-transparent electrode 16 or connected to it. Likewise, in this embodiment, the partially reflective semi-transparent electrode 16 would not employ vias to electrode busses to provide additional current distribution in an OLED device. Such patterned elements require additional manufacturing process steps that raise the cost of such OLED devices and may not need to be employed in the present invention. Alternatively, patterned elements such as a grid conductors and vias with busses may be employed in concert with the present invention to further improve the conductivity of the partially reflective semi-transparent electrode 16. The partially reflective semi-transparent electrode 16 is preferably deposited directly over the organic layers 14 in a single continuous deposition step, for example by sputtering and does not require masking within the light-emitting area of the OLED device.

In operation, a voltage differential is supplied to the electrodes in the OLED device. Current flows through the organic layers 14 and light is emitted in every direction from the organic layers 14. Because of the scattering element 22, emitted light 1 in FIG. 1 does not waveguide along the organic layers 14 or through the partially reflective semi-transparent electrode 16 and is, instead, scattered through the partially reflective semi-transparent electrode 16 after one or more encounters with the scattering element 22. Because the partially reflective semi-transparent electrode 16 is partially reflective, it will also reflect some light back into the organic layers 14. The reflection of light between the reflective element 12 and partially reflective semi-transparent electrode 16 would, in the absence of the scattering element 22, create a microcavity, the frequency of whose emitted light would have an angular dependence and whose light could effectively pass through a partially reflective semi-transparent electrode. However, in the presence of the scattering element 22, any such angular dependence will tend to be destroyed. Hence, the present invention combines an enhanced light output and little or no angular dependence on the frequency of light emission due to the scattering layer, and increased conductivity of the transparent electrode without requiring the use of additional patterned conductors.

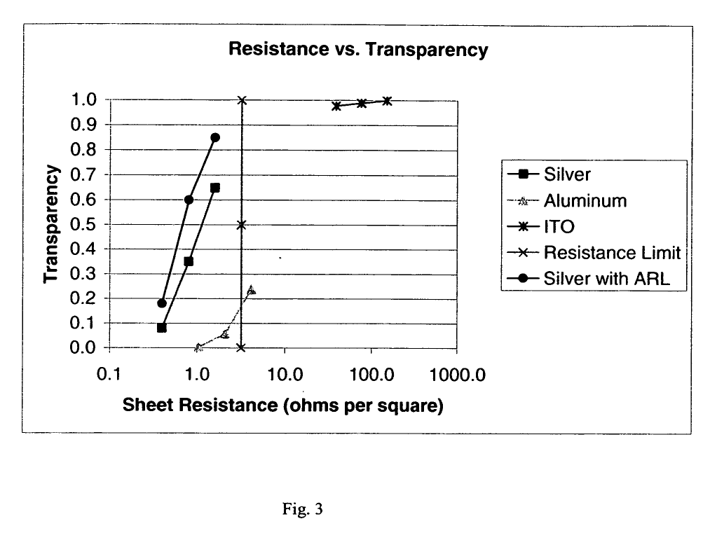

In FIG. 3, the transparency and sheet resistance of a variety of materials coated at 10 nm, 20 nm, and 40 nm are shown. For each material, the thinner coatings are more transparent but have lower conductivity (higher sheet resistance). The thicker coatings are less transparent but have higher conductivity (lower sheet resistance). While highly transparent, ITO has lower than desired conductivity. Silver, a highly conductive metal, provides the needed conductivity, while at lower transparency. Aluminum is both less conductive and less transmissive than silver.

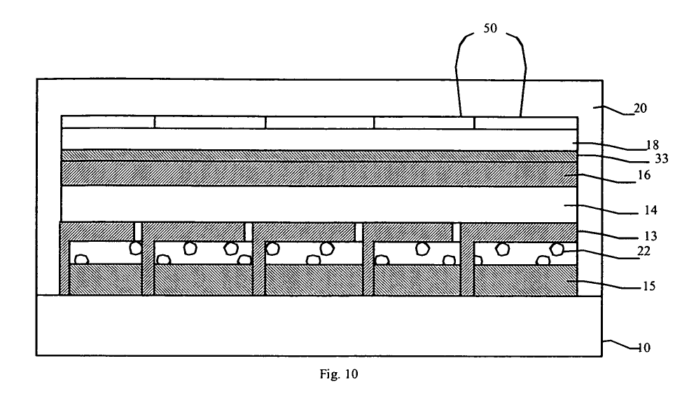

To improve transparency, a partially reflective semi-transparent metal layer electrode 16 may be used in combination with an absorption-reduction layer (ARL) 33 (FIG. 10), as described for example in Tyan et al., U.S. Pat. No. 6,861,800, to inhibit absorption of light that passes through it. By carefully controlling the relative thicknesses of the second, partially reflective semi-transparent electrode 16 and absorption-reduction layer 33, the absorption of the semi-transparent electrode, in particular a highly conductive metal electrode such as silver, may be reduced. In a particular embodiment, the absorption-reduction layer itself may be composed of a conductive transparent material. Applicants have demonstrated, e.g., an effective absorption-reduction layer comprising ITO in combination with a silver electrode. Referring again to FIG. 3, the combination of an ARL with a semi-transparent silver layer electrode may be used to provide both desired conductivity and transparency. In particular, Applicants have demonstrated that 20 nm of silver together with an ITO absorption-reduction layer provides adequate current carrying capability and excellent transparency for many flat-panel OLED device applications, for example display devices and area illumination devices. For smaller applications or those requiring lower brightness (and current density), a thinner semi-transparent cathode may be employed, for example 5 nm or 10 nm of silver, further improving transparency. For those applications requiring additional electrode conductivity, for example very large panels of OLED devices, thicker cathodes (e.g. 40 nm of silver) may be employed or the present invention may be combined with electrode strapping or electrode busses, as referenced above.

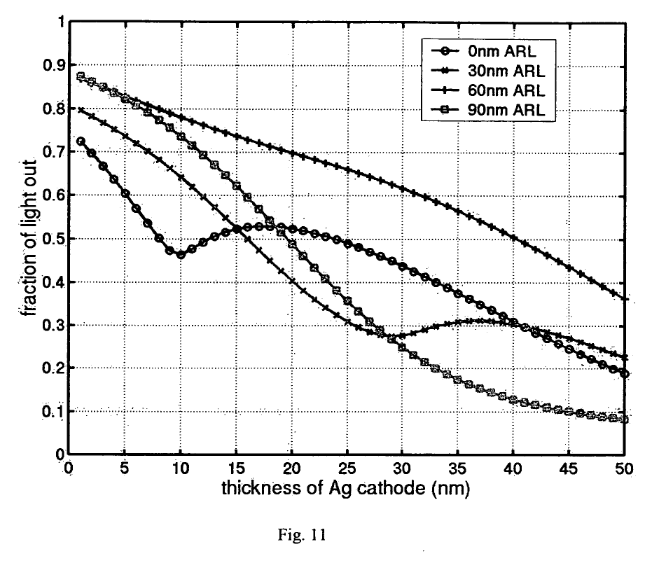

FIG. 11 is a graph of the expected fraction of light that is emitted from the device of FIG. 10 as a function of the thickness of a silver partially reflective semi-transparent electrode, for various thicknesses of an absorption-reduction layer (ARL). In the optical modeling used to produce this figure, we have assumed that the scattering element and underlying reflector result in 100% of the light being scattered back with a Lambertian distribution in the organic layers 14 and that air lies directly above absorption-reduction layer 33. The organic layers 14, transparent electrode 13, and the absorption-reduction layer 33 are all assumed to have a refractive index n=1.8, while the real and imaginary parts of the refractive index for the silver partially reflective semi-transparent electrode have been measured by spectroscopic ellipsometry and then approximately corrected for the effect of the decrease in electron scattering length introduced by the finite thickness of the metal film [U. Kreibig, Zeitschrift für Physic B 31, 39-47 (1978); R. Ruppin and H. Yatom, Physica Status Solidi (b) 74, 647-654 (1976)]. The effects of a small amount of light absorption within the various layers 13, 14, and 33 of the device or absorption by the scattering element 22 or reflective layer 15 have also been investigated within the model and do result in further reductions in the light output of the device that can, nonetheless, be minimized through the judicious choice of materials and layer thicknesses.

Scattering element 22 may comprise a volume scattering layer or a surface scattering layer. In certain embodiments, e.g., scattering element 22 may comprise materials having at least two different refractive indices. The scattering element 22 may comprise, e.g., a matrix of lower refractive index and scattering elements having a higher refractive index. Alternatively, the matrix may have a higher refractive index and the scattering elements may have a lower refractive index. For example, the matrix may comprise silicon dioxide or cross-linked resin having indices of approximately 1.5, or silicon nitride with a much higher index of refraction. If scattering element 22 has a thickness greater than approximately one-tenth the wavelength of the emitted light, then it is desirable for the index of refraction of at least one material in the scattering element 22 to be approximately equal to or greater than the refractive indices of the organic layers 14. This is to insure that all of the light trapped in the organic layers 14 and partially reflective semi-transparent electrode 16 can experience the direction altering effects of scattering element 22. If scattering element 22 has a thickness less than approximately one-tenth the wavelength of the emitted light, then the materials in the scattering layer need not have such a preference for their refractive indices.

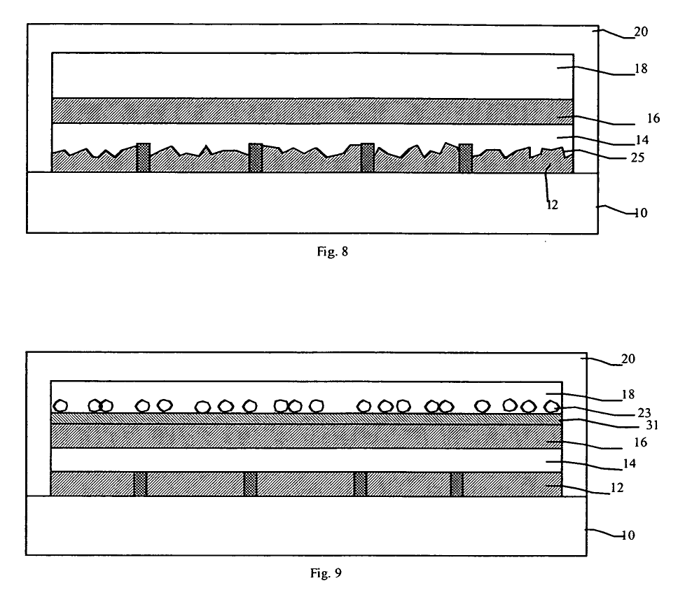

In an alternative embodiment shown in FIG. 7, scattering element 22 may comprise particles 23 deposited on another layer, e.g., particles of titanium dioxide may be coated over partially reflective electrode 16 to scatter light. Preferably, such particles are at least 100 nm in diameter to optimize the scattering of visible light. In a further top-emitter alternative shown in FIG. 8, scattering element 22 may comprise a rough, diffusely reflecting surface 25 of reflective element 12 itself.

The scattering element 22 is typically adjacent to and in contact with, or close to, an electrode to defeat total internal reflection in the organic layers 14 and partially reflective semi-transparent electrode 16. However, if the scattering element 22 is between the reflective element 12 and partially reflective semi-transparent electrode 16, it may not be necessary for the scattering element to be in contact with reflective element 12 or partially reflective semi-transparent electrode 16 so long as it does not unduly disturb the generation of light in the organic layers 14. According to an embodiment of the present invention, light emitted from the organic layers 14 can waveguide along the organic layers 14 and partially reflective semi-transparent electrode 16 combined. The scattering element 22 or surface 25 disrupts the total internal reflection of light in the combined layers 14 and 16 and redirects some portion of the light out of the combined layers 14 and 16.

Whenever light crosses an interface between two layers of differing index, a portion of the light is reflected and another portion is refracted (except for the case of total internal reflection). Unwanted reflections can be reduced by the application of standard thin anti-reflection layers. Use of anti-reflection layers may be particularly useful on both sides of the encapsulating cover 20 for top emitters or on the substrate 10 for a bottom emitter. Referring to FIG. 1, an anti-reflective layer 21 is illustrated on the outside of transparent cover 20.

Referring back to FIG. 6, an embodiment of the present invention having a scattering element 22 between reflector 15 and transparent electrode 13 is illustrated. Various embodiments of the invention, for example FIGS. 1, 6, and 7, have the advantage that they may be readily manufactured by coating scattering particles, such as titanium dioxide, on inorganic layers without disturbing the organic layers 14, therefore enabling a higher-yield manufacturing process. For example, spin coating may be employed. Alternatively, in the embodiment of FIG. 6, photolithographic processes may be employed to create scattering structures in the scattering element 22. Applicants have demonstrated the efficacy of the present invention by experimentally constructing an OLED device of the type shown in FIG. 6, having a 20 nm thick Ag cathode and a diffusely reflecting scattering layer 22 beneath a transparent ITO anode. Enhanced light output was demonstrated for the device compared to a control device that did not employ scattering layer 22. Decreased angle dependency for the wavelength of emitted light was also demonstrated.

The scattering element 22 can employ a variety of materials. For example, randomly located spheres of titanium dioxide may be employed in a matrix of polymeric material. Alternatively, a more structured arrangement employing ITO, silicon oxides, or silicon nitrides may be used. In a further embodiment, the refractive materials may be incorporated into the electrode itself so that the electrode is a scattering layer. Shapes of refractive elements may be cylindrical, rectangular, or spherical, but it is understood that the shape is not limited thereto. The difference in refractive indices between materials in the scattering element 22 may be, for example, from 0.3 to 3, and a large difference is generally desired. The thickness of the scattering layer, or size of features in, or on the surface of, a scattering layer may be, for example, 0.03 to 50 μm. It is generally preferred to avoid diffractive effects by the scattering layer. Such effects may be avoided, for example, by locating features randomly or by ensuring that the sizes or distribution of the refractive elements are not the same as the wavelength of the color of light emitted by the device from the light-emitting area.

The scattering element 22 should be selected to get the light out of the OLED device as quickly as possible so as to reduce the opportunities for re-absorption by the various layers of the OLED device. If the scattering element 22 is to be located between the organic layers 14 and a transparent low-index element 18, or between the organic layers 14 and a reflector 15, then the total diffuse transmittance of the same layer coated on a glass support should be high (preferably greater than 80%). In other embodiments, where the scattering layer 22 is itself desired to be reflective, then the total diffuse reflectance of the same layer coated on a glass support should be high (preferably greater than 80%). In all cases, the absorption of the scattering layer should be as low as possible (preferably less than 5%, and ideally 0%).

Materials of the light scattering element 22 can include organic materials (for example polymers or electrically conductive polymers) or inorganic materials. The organic materials may include, e.g., one or more of polythiophene, PEDOT, PET, or PEN. The inorganic materials may include, e.g., one or more of SiOₓ (x>1), SiNₓ (x>1), Si₃N₄, TiO₂, MgO, ZnO, Al₂O₃, SnO₂, In₂O₃, MgF₂, and CaF₂. The scattering element 22 may comprise, for example, silicon oxides and silicon nitrides having a refractive index of 1.6 to 1.8 and containing particles of titanium dioxide having a refractive index of 2.3 to 3. Polymeric materials having refractive indices in the range of 1.4 to 1.6 may be employed having a dispersion of particles or other refractive elements of material with a higher refractive index, for example titanium dioxide.

Conventional lithographic means can be used to create the scattering layer using, for example, photo-resist, mask exposures, and etching as known in the art. Alternatively, coating may be employed in which a liquid, for example polymer having a dispersion of titanium dioxide, may form a scattering element 22.

One problem that may be encountered with such scattering layers is that the electrodes may tend to fail open at sharp edges associated with the scattering elements in the element 22. Although the scattering layer may be planarized, typically such operations do not form a perfectly smooth, defect-free surface. To reduce the possibility of shorts between the electrodes, a short-reduction layer may be employed between the electrodes. Such a layer is a thin layer of high-resistance material (for example having a through-thickness resistance (defined as a product of the bulk resistivity and the film thickness) between 10⁻⁷ ohm-cm² to 10³ ohm-cm²). Because the short-reduction layer is very thin, device current can pass between the electrodes through the device layers but leakage current through the shorts is much reduced. Such layers are described in co-pending, commonly assigned U.S. Ser. No. 10/822,517, filed Apr. 12, 2004, the disclosure of which is incorporated herein by reference.

Most OLED devices are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890 issued May 8, 2001 to Boroson et al. In addition, barrier layers such as SiOₓ (x>1), Teflon, and alternating inorganic/polymeric layers are known in the art for encapsulation.

In particular, as illustrated in FIG. 9, very thin layers of transparent encapsulating materials 31 may be deposited on the partially reflective semi-transparent electrode 16. In this case, the scattering element particles 23 may be deposited over the layers of encapsulating materials 31. This structure has the advantage of protecting the partially reflective semi-transparent electrode 16 during the deposition of the scattering element 22. In such embodiment, in order for the scattering element to be optically integrated into the OLED device for scattering light emitted by the light-emitting layer and reflected by the reflective element and the partially reflective semi-transparent electrode, the layers of transparent encapsulating material 31 and electrode 16 must have a refractive indices comparable to or higher than the refractive index of the organic layers 14, or are very thin (e.g., less than about 0.2 micron) so that waveguided light in the partially reflective electrode 16 and organic layers 14 will pass through the layers of transparent encapsulating material 31 and be scattered by the scattering element particles 23.

In one embodiment of the present invention, the organic layers are patterned with a variety of organic materials and produce a variety of colored light defining the colored sub-pixels of a full-color OLED device. In an alternative embodiment, the light emitted from the light-emitter layer is broadband light, for example white, and color filters may be located over the light-emitting layers 14 to provide different colors of light. Referring to FIG. 10, color filters 40 may be formed on the inside or outside of the cover or, alternatively, on the partially reflective semi-transparent electrode 16, or absorption-reduction layer 33.

OLED devices of this invention can employ various well-known optical effects in order to enhance their properties if desired. This includes optimizing layer thicknesses to yield maximum light transmission, providing anti-glare or anti-reflection coatings over the display, providing a polarizing medium over the display, or providing colored, neutral density, or color conversion filters over the display. Filters, polarizers, and anti-glare or anti-reflection coatings may be specifically provided over the cover or as part of the cover.

The present invention may also be practiced with either active- or passive-matrix OLED devices. It may also be employed in display devices or in area illumination devices. In a preferred embodiment, the present invention is employed in a flat-panel OLED device composed of small molecule or polymeric OLEDs as disclosed in but not limited to U.S. Pat. No. 4,769,292, issued Sep. 6, 1988 to Tang et al., and U.S. Pat. No. 5,061,569, issued Oct. 29, 1991 to VanSlyke et al. Many combinations and variations of organic light-emitting displays can be used to fabricate such a device, including both active- and passive-matrix OLED displays having either a top- or bottom-emitter architecture.

The invention has been described in detail with particular reference to certain preferred embodiments thereof, but it will be understood that variations and modifications can be effected within the spirit and scope of the invention.

### PARTS LIST

1 light rays
10 substrate
12 reflective element
13 transparent electrode
14 organic layer(s)
15 reflector
16 partially reflective semi-transparent electrode
17 transparent electrode
18 transparent low-index element
19 gap
20 encapsulating cover
21 anti-reflection layer
22 scattering layer
23 scattering particles
25 scattering reflective electrode surface
30 pixels
31 layer of encapsulating material
32 pixels
33 absorption-reduction layer
34 pixels
36 pixels
38 pixels
40 via
41 transparent electrode bus
42 insulator
50 color filters

1. An organic light-emitting diode (OLED) device, comprising: a reflective element, a partially reflective semi-transparent electrode through which light from the OLED is emitted, and at least one layer of organic light-emitting material disposed between the reflective element and the partially reflective semi-transparent electrode; wherein either the reflective element comprises a reflective electrode or a transparent electrode is positioned between the reflective element and the organic light emitting material,
and further comprising a light scattering element optically integrated into the OLED device for scattering light emitted by the light-emitting layer and reflected by the reflective element and the partially reflective semi-transparent electrode.

2. The OLED device of claim 1 wherein the light scattering element is located between the reflective element and the partially reflective semi-transparent electrode, or is optically integrated into the partially reflective semi-transparent electrode or the reflective element.

3. The OLED device of claim 1 wherein the partially reflective semi-transparent electrode has a transparency of from 20% to 90% for light of 550 nm wavelength.

4. The OLED device of claim 1 further comprising a substrate on which the reflective element, partially reflective semi-transparent electrode, and at least one layer of organic light-emitting material are formed and wherein the OLED device is a top-emitter and the reflective element is adjacent to the substrate.

5. The OLED device of claim 4, further comprising a protective layer formed over the partially reflective semi-transparent electrode.

6. The OLED device of claim 1 further comprising a substrate on which the reflective element, partially reflective semi-transparent electrode, and at least one layer of organic light-emitting material are formed and wherein the OLED device is a bottom-emitter and the partially reflective semi-transparent electrode is adjacent to the substrate.

7. The OLED device of claim 1, wherein the partially reflective semi-transparent electrode is unpatterned.

8. The OLED device of claim 1, wherein the partially reflective semi-transparent electrode has a thickness greater than 5 nanometers.

9. The OLED device of claim 1, wherein the partially reflective semi-transparent electrode has a sheet resistance less than 3.20 ohms per square.

10. The OLED device of claim 1, wherein the partially reflective semi-transparent electrode comprises metal, metal oxides, or a metal alloy.

11. The OLED device of claim 10, wherein the partially reflective semi-transparent electrode comprises silver, aluminum, lithium, or magnesium.

12. The OLED device of claim 1, wherein the scattering element is adjacent to and in contact with an electrode.

13. The OLED device of claim 1, wherein the scattering element is optically integrated with the partially reflective semi-transparent electrode.

14. The OLED device of claim 1, wherein the scattering element is optically integrated with the reflective element.

15. The OLED device of claim 1, wherein the scattering element is an electrode.

16. The OLED device of claim 1, wherein the scattering element is the reflective element.

17. The OLED device of claim 1, wherein the scattering element is located between the reflective element and a transparent electrode.

18. The OLED device of claim 17, wherein the scattering element is adjacent to, and in contact, with both the reflective element and the transparent electrode.

19. The OLED device of claim 1, wherein the scattering element includes a matrix material and a scattering material with different indices of refraction.

20. The OLED device of claim 1, wherein the OLED device is a display or an area illumination device.

21. The OLED device of claim 1, further comprising an absorption-reduction layer located over the partially reflective semi-transparent electrode.

22. The OLED device of claim 21, wherein the absorption-reduction layer is electrically conductive.

23. The OLED device of claim 22, wherein the absorption-reduction layer comprises ITO.
